(19) United States
(12) Patent Application Publication
(10) Pub. No.: US 2012/0128039 A1
(43) Pub. Date: May 24, 2012

(54) METHOD AND APPARATUS FOR TRANSMITTING AND RECEIVING CONTROL CHANNEL FOR RELAY BACKHAUL LINK IN WIRELESS COMMUNICATION SYSTEM

(75) Inventors: So Yeon Kim, Gyeonggi-do (KR); Jae Hoon Chung, Gyeonggi-do (KR); Yeong Hyeon Kwon, Gyeonggi-do (KR)

(73) Assignee: LG ELECTRONICS INC., Seoul (KR)

(21) Appl. No.: 13/383,576

(22) PCT Filed: Jul. 16, 2010
(86) PCT No.: PCT/KR10/04651

§ 371 Date: Jan. 11, 2012

Related U.S. Application Data
(60) Provisional application No. 61/226,254, filed on Jul. 16, 2009.
(60) Provisional application No. 61/227,800, filed on Jul. 23, 2009.

(51) Int. Cl. H04B 17/02; H04L 25/20

(52) U.S. Cl. 375/211

(57) ABSTRACT

The present invention relates to a method and an apparatus for transmitting and receiving a control channel for a relay backhaul link in a wireless communication system. In the transmission method of a control channel for a backhaul link in a base station of a wireless communication system according to one aspect of the present invention, the base station (BS) divides and allocates a 1^{st} relay physical downlink control channel (hereinafter referred to as R-PDCCH) symbol to a plurality of OFDM symbols in the R-PDCCH region, and interleaves, by OFDM symbol, part of the 1^{st} R-PDCCH symbols that are allocated to the plurality of OFDM symbols, respectively.

### FIELD OF THE INVENTION

The present invention relates to a wireless communication system, and more particularly to a method and apparatus for transmitting and receiving a control channel for a relay backhaul link in a wireless communication system.

### BACKGROUND ART

First, a frame structure and a resource structure of a wireless communication system will be described with reference to FIGS. 1 and 2. FIG. 1 is a diagram illustrating a frame structure of a wireless communication system. Referring to FIG. 1, one frame includes 10 subframes, and one subframe includes two slots. A time required to transmit one subframe is defined as a Transmission Time Interval (TTI). For example, one subframe may have a length of 1 ms, and one slot may have a length of 0.5 ms.

One slot may include a plurality of Orthogonal Frequency Division Multiplexing (OFDM) symbols. The OFDM symbol may be referred to as an SC-FDMA symbol or a symbol duration.

One slot may include 7 or 6 OFDM symbols according to a cyclic prefix (CP) length. The Long Term Evolution (LTE) system includes a normal CP and an extended CP. As to the normal CP, one slot may include 7 OFDM symbols. As to the extended CP, one slot may include 6 OFDM symbols. The extended CP is used for a high delay spread.

FIG. 2 shows a resource structure of one DL slot. Referring to FIG. 2, one slot includes 7 OFDM symbols. A resource element (RE) is a resource region including one OFDM symbol and one subcarrier. A resource block (RB) is a resource region including a plurality of OFDM symbols and a plurality of subcarriers. For example, the RB may include 7 OFDM symbols in a time domain and 12 subcarriers in a frequency domain. The number of RBs contained in one slot may be determined according to downlink bandwidth.

FIG. 3 is a diagram showing the structure of a downlink subframe.

Referring to FIG. 3, a maximum of three OFDM symbols of a front portion of a first slot within one subframe corresponds to a control region to which a control channel is allocated. The remaining OFDM symbols correspond to a data region to which a Physical Downlink Shared Channel (PDSCH) is allocated. Examples of downlink control channels used in the LTE system include, for example, a Physical Control Format Indicator Channel (PCFICH), a Physical Downlink Control Channel (PDCCH), a Physical Hybrid automatic repeat request Indicator Channel (PHICH), etc.

The PCFICH is transmitted in a first OFDM symbol of a subframe, and includes information about the number of OFDM symbols used to transmit the control channel in the subframe. The PHICH includes a HARQ ACK/NACK signal as a response to uplink transmission. The control information transmitted through the PDCCH is referred to as Downlink Control Information (DCI). The DCI includes uplink or downlink scheduling information or an uplink transmission power control command.

The PDCCH transmits a PDSCH transmission format and PDSCH resource allocation information.

In order to extend cell coverage of a mobile communication system and to increase system throughput, multi-hop transmission has been proposed. Multi-hop transmission is a communication method using a relay. The relay is referred to as a relay station (RS), a relay node (RN), etc.

A link between a base station (BS) and a relay node (RN) is referred to as a backhaul link, and a link between a relay node (RN) and a user equipment (UE) is referred to as an access link.

With development of the relay node (RN), there is a need to define a method for transmitting and receiving a control channel of a backhaul link.

### DETAILED DESCRIPTION OF THE INVENTION

### Technical Problem

As described above, with development of a relay node (RN), it is necessary to define a method for transmitting and receiving a control channel of a backhaul link.

An object of the present invention is to provide a method for transmitting and receiving a control channel of a backhaul link.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for transmitting a control channel for a backhaul link by a base station (BS) of a wireless communication system including distributing and assigning a first relay physical downlink control channel (R-PDCCH) symbol to a plurality of OFDM symbols of an R-PDCCH region; and interleaving some parts of the first R-PDCCH symbol assigned to each OFDM symbol, on an OFDM symbol basis.

The base station (BS) may further include distributing and assigning a second PDCCH symbol to the OFDM symbols; and multiplexing, in association with each OFDM symbol, some parts of the first R-PDCCH symbol assigned to the same OFDM symbol and some parts of the second PDCCH symbol.

The base station (BS) may include interleaving some parts of the first R-PDCCH symbol assigned to each of the OFDM symbol and some parts of the second R-PDCCH symbol, on an OFDM symbol basis.

If the number of resource elements (REs) contained in the R-PDCCH symbol is exactly divided by the number of OFDM symbols, the base station (BS) assigns resource units, the number of which is identical to a quotient obtained when the number of REs contained in the R-PDCCH symbol is divided by the number of OFDM symbols, to each of the OFDM symbols.

The base station (BS) may enable some parts of the R-PDCCH symbol assigned to each OFDM symbol to be denoted by an integer multiple of an interleaving unit.

In another aspect of the present invention, a method for receiving a control channel for a backhaul link by a relay node (RN) of a wireless communication system includes receiving a relay physical downlink control channel (R-PDCCH) generated when a first R-PDCCH symbol is distributed and assigned to a plurality of OFDM symbols of an R-PDCCH region and some parts of the first R-PDCCH symbol assigned to each OFDM symbol are interleaved on an OFDM symbol basis; and decoding the R-PDCCH.

In another aspect of the present invention, a base station includes a processor for generating a first relay physical downlink control channel (R-PDCCH), by distributing/assigning a first R-PDCCH symbol to a plurality of OFDM symbols of an R-PDCCH region and interleaving some parts of the first R-PDCCH symbol assigned to each OFDM symbol on an OFDM symbol basis; and a transmission module for transmitting the first R-PDCCH.

In another aspect of the present invention, a relay node (RN) includes a reception module for receiving a relay physical downlink control channel (R-PDCCH) generated when a first R-PDCCH symbol is distributed and assigned to a plurality of OFDM symbols of an R-PDCCH region and some parts of the first R-PDCCH symbol assigned to each OFDM symbol are interleaved on an OFDM symbol basis; and a processor for decoding the R-PDCCH.

### Effects of the Invention

As is apparent from the above description, a method for transmitting and receiving a control channel of a backhaul link according to exemplary embodiments of the present invention can perform interleaving for each symbol when generating a control channel of a backhaul link, resulting in increased diversity.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a diagram illustrating a frame structure of a wireless communication system.

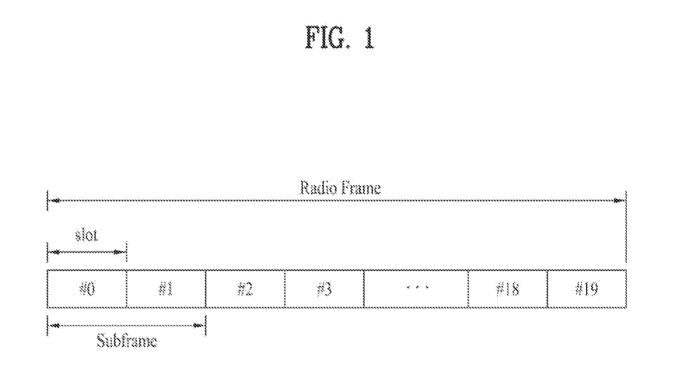

FIG. 2 shows a resource structure of one DL slot.

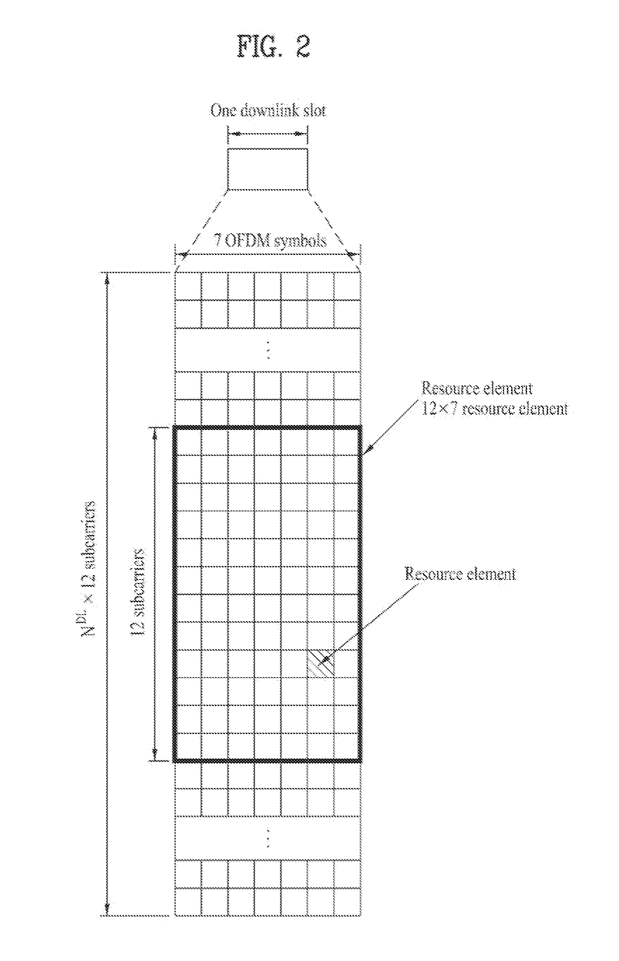

FIG. 3 shows a downlink subframe structure.

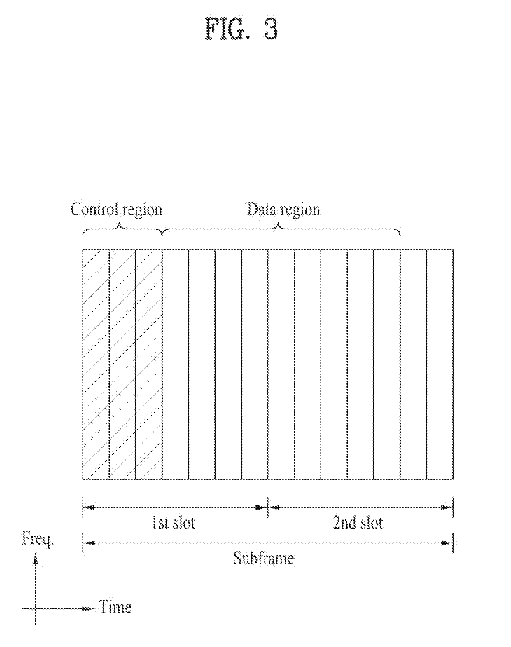

FIG. 4 shows a network including a relay node (RN).

FIG. 5 shows a localized R-PDCCH region.

FIG. 6 shows a distributed R-PDCCH region.

FIG. 7 is a flowchart illustrating a method for transmitting an R-PDCCH transmission method according to a first embodiment of the present invention.

FIG. 8(a) shows an exemplary case in which N PRBs occupy all or some parts of R-PDCCH of one relay node (RN), and FIG. 8(b) shows an exemplary case in which R-PDCCH of each RN is transmitted in units of a smaller unit than N PRBs.

FIG. 9 is a conceptual diagram illustrating a physical resource mapping method of another frequency domain according to a second embodiment of the present invention.

FIG. 10 is a conceptual diagram illustrating a physical resource mapping method of another time domain according to a second embodiment of the present invention.

FIG. 11 is a block diagram illustrating a base station (BS) and a relay node (RN) applicable to embodiments of the present invention.

### BEST MODE FOR CARRYING OUT THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details. For example, the following description will be given centering upon a mobile communication system serving as a 3GPP 802.16 system, but the present invention is not limited thereto and the remaining parts of the present invention other than unique characteristics of the 3GPP 802.16 system are applicable to other mobile communication systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the following description, a terminal may refer to a mobile or fixed user equipment (UE), for example, a user equipment (UE), a mobile station (MS) and the like. Also, a base station (BS) may refer to an arbitrary node of a network end which communicates with the above terminal, and may include a Node B, an eNode B, a base station (BS) and the like.

First, the relay node (RN) will hereinafter be described in detail.

Relays are classified into an L1 relay, an L2 relay, and an L3 relay according to function thereof in multi-hop transmission.

The L1 relay usually functions as a repeater. Thus, the L1 relay simply amplifies a signal received from a BS or a UE and transmits the amplified signal to the UE or the BS. Because the L1 relay does not decode a received signal, transmission delay of the signal is short. Despite this benefit, noise is also amplified because the L1 relay does not separate the signal from the noise. To obviate this problem, an advanced repeater or smart repeater capable of uplink power control or self-interference cancellation may be used.

The L2 relay may perform a decode-and-forward function. The L2 relay can transmit UE-plane traffic to L2. While the L2 relay does not amplify noise, decoding of the relay unavoidably increases transmission delay.

The L3 relay whose operation is depicted as self-backhauling can transmit an Internet Protocol (IP) packet to L3. As it is equipped with a Radio Resource Control (RRC) function, the L3 layer serves as a small-scale BS.

In addition, relays may be classified into a fixed relay node (RN), a nomadic RN, and a mobile RN according to mobility thereof.

The fixed RN is permanently fixed for use in a shadowing area or for coverage extension. The fixed RN may function as a simple repeater. The nomadic RN is temporarily installed when users are rapidly increasing in number, or is movable within a building. The mobile RN can be installed in public transportation such as a bus or subway. Mobility of the RN should be supported.

In addition, the RNs are classified into an inband RN and an outband RN according to links between RNs and networks.

A link between the network and the inband RN is identical to a link between a network and a UE. A link between the network and the outband RN is different from a link between the network and the UE.

With respect to knowledge of presence of a relay node (RN) in a UE, relay nodes (RNs) are classified into a transparent RN and a non-transparent RN. According to the transparent RN, a UE is not aware of whether or not it is communicating with a network via the RN. According to the non-transparent RN, a UE is aware of whether or not it is communicating with a network via the RN.

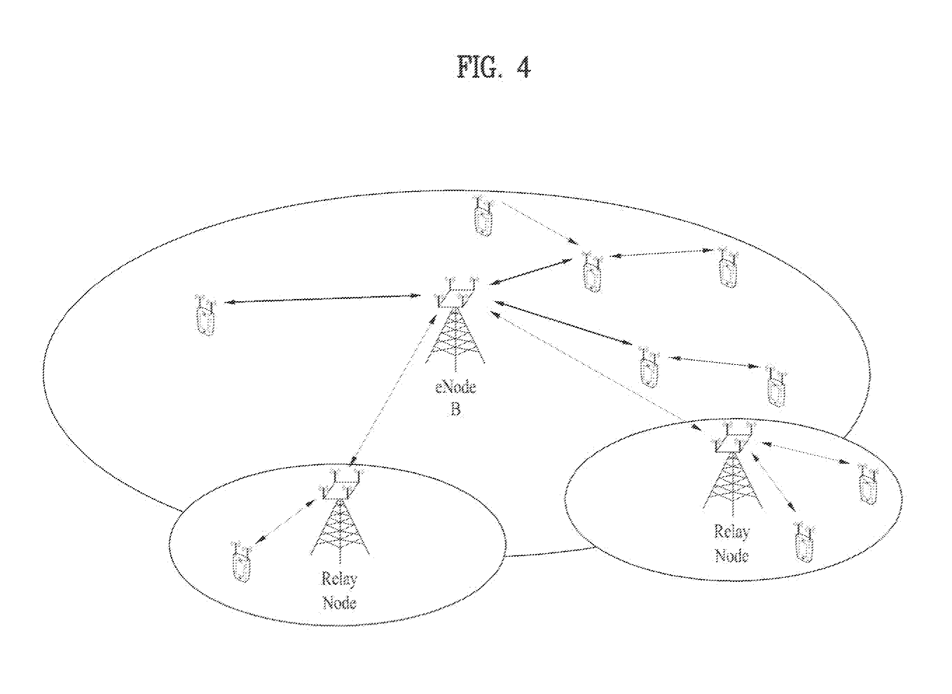

FIG. 4 shows a network including a relay node (RN). As shown in FIG. 4, the basic object of the RN is to extend a service coverage of the BS or to facilitate service for the shadowing area.

The relay node (RN) may be regarded as a part of a donor cell covered by a BS. In the case in which the relay node (RN) is a part of a donor cell, the relay node does not have its own cell ID because it cannot control its cell and UEs of the cell. Nonetheless, the RN may still have a relay ID. At least part of Radio Resource Management (RRM) is controlled by the BS to which the donor cell belongs, while parts of the RRM may be controlled by the relay node (RN).

The relay node (RN) can control cells of its own. As such, the relay node (RN) may manage one or more cells and each of the cells may have a unique physical-layer cell ID. The relay node (RN) may have the same RRM function as a BS. From the perspective of a UE, there is no difference between accessing a cell controlled by the relay node and accessing a cell controlled by a normal BS.

In general, a link between the BS and the relay node (RN) is referred to as a backhaul link, and a link between the relay node (RN) and the UE is referred to as an access link.

Next, a control channel of the backhaul link will be described in detail.

A subframe available for a backhaul link is semi-statically assigned. A relay physical downlink control channel (R-PDCCH) is a control channel of a backhaul link.

R-PDCCH may be scheduling information of a relay physical downlink shared channel (R-PDSCH) of the corresponding subframe in which R-PDCCH is transmitted, or may also be scheduling information of an R-PDSCH of any subframe other than the subframe used for R-PDCCH transmission from among semi-statically allocated subframes. That is, one piece of R-PDCCH scheduling information may be valid for one or more subframes.

The R-PDCCH can dynamically or semi-statically transmit R-PUSCH scheduling information. That is, the R-PDCCH may be scheduling information of R-PUSCH transmitted to the corresponding subframe, or may also be scheduling information of R-PUSCH of any subframe other than the subframe used for R-PDCCH transmission from among semi-statically allocated subframes.

Predetermined physical resource blocks (PRBs) of the subframe can be semi-statically allocated for R-PDCCH transmission. Each R-PDCCH may use the subset of the semi-statically assigned PRBs. In the embodiments of the present invention, PRBs contained in the semi-statically allocated subframe for R-PDCCH transmission are referred to as an R-PDCCH region.

Resources used in the R-PDCCH region according to R-PDCCH load can be dynamically changed in units of an OFDM symbol. Resources not used for R-PDCCH transmission in the R-PDCCH region may be used for R-PDSCH or PDSCH transmission.

Information regarding the R-PDCCH region may be transmitted as cell-specific broadcasting information or cell-specific RRC signaling. There are two methods for semi-statically establishing the R-PDCCH region, i.e., a method for establishing a localized R-PDCCH region and a method for establishing a distributed R-PDCCH region.

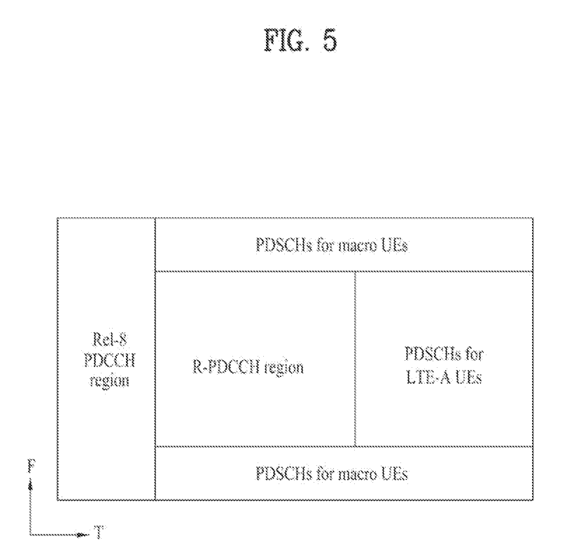

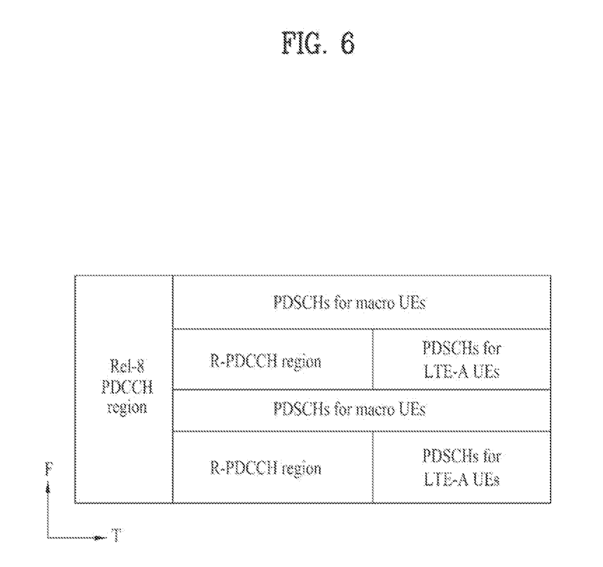

FIG. 5 shows a localized R-PDCCH region, and FIG. 6 shows a distributed R-PDCCH region. Referring to FIG. 5, the localized R-PDCCH region includes one or more contiguous PRBs. Referring to FIG. 6, at least one distributed R-PDCCH region includes one or more non-contiguous PRBs.

A relay physical control format indicator channel (R-PCFICH) will hereinafter be described in detail.

PCFICH used in the LTE Rel-8 system is a channel for transmitting information regarding a control region for PDCCH transmission, and indicates how many OFDM symbols are contained in the control region. In the LTE Rel-8 system, the control region includes a maximum of three OFDM symbols.

R-PCFICH serves as a format indicator channel of R-PDCCH. R-PCFICH is a channel for transmitting information regarding R-PDCCH transmission resources, information regarding an R-PDCCH transmission format, etc.

R-PCFICH is used as PCFICH for a relay node (RN), and can transmit information indicating how many OFDM symbols are contained in the R-PDCCH region. In addition, R-PCFICH may indicate configuration of an actual PRB used by an R-PDCCH on a frequency axis, and may include an index depending upon the increasing PRB according to a predetermined rule. For example, when a default value or a minimum value is determined, R-PCFICH may indicate the increasing PRB using a multiple of a default or minimum value. In other words, the R-PCFICH can transmit resource information of at least one domain from among time and frequency domains occupied by the R-PDCCH region.

R-PCFICH configuration and an R-PCFICH transmission method according to an embodiment of the present invention when R-PCFICH is needed will hereinafter be described in detail.

If the R-PDCCH region of a frequency axis is notified through semi-static signaling, R-PCFICH can indicate the R-PDCCH region of a time axis. The R-PDCCH region of the frequency axis is semi-statically fixed and the R-PDCCH region of the time axis is variable, R-PCFICH indicates the R-PDCCH region of the time axis. Therefore, R-PCFICH may be information indicating how many OFDM symbols are used by the R-PDCCH region, and may transmit information regarding the R-PDCCH region of the time axis in units of one OFDM symbol in the same manner as in a PCFICH for macro UEs.

While the PDCCH region of macro UEs is transmitted over the entire system bandwidth, the R-PDCCH region is transmitted through a limited number of PRBs. Thus, in order to indicate the R-PDCCH region in units of an OFDM symbol, many more bit numbers may be requested. While the PDCCH region of macro UEs uses a maximum of 3 OFDM symbols, the R-PDCCH region of relay nodes are transmitted on a limited frequency axis, such that there is a high probability of using three or more OFDM symbols.

PCFICH indicating the PDCCH region of macro UEs uses 2 bits to express a maximum of 3 OFDM symbols. The PCFICH supports a 1/16 coding rate and uses QPSK modulation, such that 16 resource elements (REs) are used.

Provided that the remaining 11 OFDM symbols other than the macro PDCCH region in a normal cyclic prefix (CP) subframe are used as the R-PDCCH region, an R-PCFICH requires 4 bits. In addition, the R-PCFICH must be coded at a low coding rate in such a manner that the R-PCFICH can be received by all relay nodes or LTE-A UEs. As a result, the amount of resources used for R-PCFICH transmission is about double that of PCFICH.

In order to minimize bits and resources used for R-PCFICH transmission as well as to effectively indicate the R-PDCCH region, two or more OFDM symbol units may be grouped to indicate the R-PDCCH region. Table 1 shows one case for indicating the R-PDCCH region by grouping two OFDM symbol units and another case for indicating the R-PDCCH region by grouping three OFDM symbol units.

TABLE 1

| | OFDM symbols for R- | OFDM symbols for R- |
|---|---|---|
| | PDCCH transmission | PDCCH transmission |
| Bit | (indication in units of 2 | (indication in units of 3 |
| representation | OFDM symbols) | OFDM symbols) |
| 0 | 3rd, 4th | 3rd, 4th, 5th |
| 1 | 5th, 6th | 6th, 7th, 8th |
| 2 | 7th, 8th | All symbols (9th, 10th, 11th) |
| 3 | All symbols (9th, 10th, | Reserved |
| | 11th) | |

If the amount of information indicated by R-PCFICH is 2 states, one state may indicate a predetermined number of OFDM symbols, and the other state may indicate all OFDM symbols or OFDM symbols available in the first or second slot of a macro subframe.

If the amount of information indicated in Table 1 is 4 states, the corresponding value may be determined to be a predetermined number of OFDM symbols as shown in Table 1, or it may also be possible to determine the number of OFDM symbols to be non-uniformly used. For example, each state may indicate one OFDM symbol, two OFDM symbols, three OFDM symbols, all the subframes, or one slot. Therefore, when defining a relay zone according to the number of relay nodes, it is possible to efficiently use resources.

Although Table 1 shows a normal CP subframe on the condition that a macro PDCCH is transmitted using a maximum of 3 OFDM symbols, it should be noted that Table 1 can also be equally applied to the size of a macro PDCCH region or the extended CP subframe, etc.

The base station (BS) maps R-PCFICH to a resource region, and transmits the mapped result.

R-PCFICH is information commonly used by all relay nodes belonging to one base station (BS), such that it can be defined as cell-specific information.

The R-PCFICH can be transmitted through the R-PDCCH region, the macro PDCCH region, or the data region.

The R-PCFICH can be transmitted through a fixed region of the R-PDCCH region. The R-PCFICH is a channel indicating resource information of a time axis of the R-PDCCH region. In order to transmit R-PCFICH information within a variable time domain, the R-PCFICH information can always be transmitted through a first OFDM symbol of the R-PDCCH region. In addition, in order to obtain frequency diversity, the base station (BS) may distribute and map the R-PCFICH on a frequency axis at regular intervals.

Alternatively, it may also be possible to use the legacy PCFICH mapping method using only scaling based on a bandwidth of the R-PDCCH region.

The base station (BS) may transmit R-PCFICH through the macro PDCCH region in such a manner that the R-PCFICH is not located in a variable R-PDCCH region. In order to transmit R-PCFICH through the macro PDCCH region, the R-PCFICH must be transmitted using a CCE unit used in the macro PDCCH region. For R-PCFICH reliability, the R-PCFICH can be transmitted using a relatively high aggregation level such as 4 or 8. In order to transmit the R-PCFICH to the macro PDCCH region, using one or more CCEs contained in a UE specific search space may be preferable to guarantee a common search space. For R-PCFICH transmission, a specific CCE index may be fixedly used in a search space of the macro PDCCH region. CCEs for constructing a PDCCH in the macro PFCCH region are distributed throughout the entire system bandwidth and the time domain of the PDCCH region and are then transmitted, such that the R-PCFICH is transmitted using one or more aggregated CCEs, resulting in frequency and time diversity effects.

If the R-PDCCH region is dynamically changed on a subframe basis or is semi-dynamically changed at intervals of a predetermined time, the R-PCFICH may be transmitted on a subframe basis or on a specific period basis. That is, R-PCFICH can be dynamically transmitted for each subframe for dynamic R-PDCCH region allocation. Alternatively, under the condition that R-PDCCH region allocation is not dynamically changed for each subframe, R-PCFICH can be semi-dynamically transmitted at intervals of a specific time for semi-dynamic R-PDCCH region allocation. In this case, the specific period may be identical to a dynamic period of the R-PDCCH region.

Alternatively, if the R-PDCCH is not transmitted at every subframe, the R-PCFICH need not be transmitted at every subframe, such that the R-PCFICH may also be transmitted to a subframe to which R-PDCCH is transmitted.

R-PCFICH may indicate information regarding the R-PDCCH region of a subframe shifted by a specific offset, instead of indicating information of the R-PDCCH region of the corresponding subframe. That is, if the R-PCFICH is transmitted at the n^{th} subframe, R-PDCCH allocation information of the R-PCFICH may be valid for the (n+k)^{th} subframe. Alternatively, the R-PDCCH allocation information of the R-PCFICH may be valid for subframes ranging from the (n+k)^{th} subframe to the next-period subframe.

If the R-PDCCH region is semi-statically allocated, R-PCFICH may be transmitted through higher layer signaling such as cell-specific or RN-specific RRC signaling. Instead of transmitting the R-PCFICH as an actual physical channel, a method for transmitting R-PCFICH transmission information through higher layer signaling may be used.

Inter-cell interference randomization effects can be achieved by applying cell-specific shifting or cell-specific scrambling to R-PCFICH transmission. The cell-specific shifting or cell-specific scrambling may be applied to any of the coded bit level, the modulated symbol level, and the resource mapping level.

The base station (BS) may not indicate the R-PDCCH region of the frequency axis through semi-static signaling, or may indicate R-PDCCH regions of the frequency and time axes through the R-PCFICH.

R-PDCCH region information of the frequency axis may be either a set of PRBs corresponding to the R-PDCCH region or indexes of PRBs corresponding to the R-PDCCH region. Assuming that a predetermined number of PRB units are designated, the R-PDCCH region information may be a PRB unit corresponding to the R-PDCCH region.

R-PDCCH region information of the time axis may be the number of OFDM symbols corresponding to the R-PDCCH region. In this case, the number of OFDM symbols may be represented in units of one OFDM symbol, or may also be represented in units of a predetermined number of OFDM symbols as shown in Table 1.

Alternatively, the base station (BS) may simultaneously display time-axis resource information and frequency-axis resource information in the form of a table, and may perform signaling of a mode. For example, Mode 0 indicates that n PRBs are allocated on a frequency axis and one OFDM symbol is allocated on a time axis.

In case of a localized R-PDCCH region, R-PCFICH may be transmitted in the corresponding R-PDCCH region. In case of a distributed R-PDCCH region, R-PCFICH including the corresponding R-PDCCH information may be transmitted in each R-PDCCH region.

Next, an exemplary case in which the R-PCFICH is not required will hereinafter be described in detail.

If information regarding the R-PDCCH regions of the frequency axis and the time axis is transmitted through semi-static signaling, or if information of the R-PDCCH region of the frequency axis is transmitted through semi-static signaling and the R-PDCCH region of the time axis is always fixed, R-PCFICH need not be used.

However, for stable operation of a specific relay node, it is preferable that the R-PDCCH be configured through time division multiplexing (TDM). For example, if it is necessary to search for the R-PDCCH region to recognize specific system information, a constant position must be provided irrespective of the size of the actually used R-PDCCH region. For this purpose, the PDCCH search space for recognizing system information needs to be equally constructed irrespective of definition of the actual R-PDCCH region.

In addition, assuming that scalability is defined, when constructing the R-PDCCH in response to the increasing number of relay nodes, it is preferable that an actual search space be constructed/increased in a TDM format. As a result, even if an unexpected problem occurs due to quality deterioration of a backhaul link, the relay node can easily recover the link.

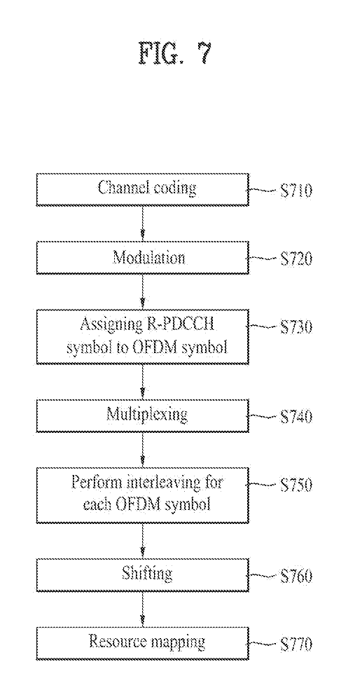

A method for transmitting and receiving R-PDCCH according to a first embodiment of the present invention will hereinafter be described with reference to FIG. 7.

One or more R-PDCCHs can be transmitted in the R-PDCCH region. Therefore, there is needed an R-PDCCH multiplexing method for effectively multiplexing one or more R-PDCCHs. One or more R-PDCCHs can be multiplexed and transmitted in the R-PDCCH region in the same manner as in transmission of one or more PDCCHs in the PDCCH region. The R-PDCCH transmission method according to an embodiment of the present invention can be applied not only to the localized R-PDCCH region but also to the distributed R-PDCCH region.

One or more PDCCHs transmitted through the PDCCH region are transmitted through channel coding, bit-level multiplexing, cell-specific scrambling, QPSK modulation, layer mapping and precoding, and CCE-to-RE mapping. The CCE-to-RE mapping process includes the REG-level subblock interleaving process and the cell-specific shifting process.

PDCCH of the LTE Rel-8 is used to encode information bits using the tail biting convolutional code. CCE aggregation level is determined according to the coding rate for encoding. CCE is a minimum unit via which one PDCCH can be transmitted, and supports an aggregation level of {1, 2, 4, 8} according to the coding rate. One CCE is composed of 36 REs, and is composed of 9 REGs.

Provided that the unit for one R-PDCCH transmission is defined as an R-CCE, the R-CCE may have the same resource configuration as in the CCE, or may have another configuration different from a CCE suitable for R-PDCCH transmission. R-CCE may include 12, 24, 36, 48 or 60 subcarriers. Resources not used for R-PDCCH transmission in the R-PDCCH region may be used for R-PDSCH and PDSCH transmission, such that it is preferable that one R-CCE unit is a multiple of PRB. In more detail, if interleaving is used for R-PDCCH transmission, one R-CCE unit corresponding to the multiple of PRB can facilitate R-PDSCH and PDSCH multiplexing. That is, R-CCE may preferably have a predetermined unit that is capable of providing the appropriate coding rate according to the size of R-PDCCH information payload. The R-CCE unit may have a multiple of PRB.

A conventional REG includes four REs. Provided that REG used for R-PDCCH transmission is defined as R-REG, the R-REG unit can use 4 REs serving as the conventional REG unit without any change. 6 REs or 12 REs (=1 PRB) may also be used as the R-REG unit. In this case, a resource structure may be configured in a localized or distributed format in such a manner that resources can be grouped in the localized or distributed format.

R-CCE aggregation level may use a CCE aggregation level of {1, 2, 4, 8} in the same manner as in the conventional PDCCH. Other aggregation levels other than the conventional aggregation level may also be utilized according to how many REs or REGs are contained in R-CCE. A search space of the R-CCE aggregation level is RN-specifically determined, such that blind decoding may be derived from all available combinations. Information as to which aggregation level is used for decoding for each relay node (RN) may be designated through semi-static RRC signaling, semi-dynamic RRC signaling, or L1/L2 signaling.

FIG. 7 is a flowchart illustrating a method for transmitting an R-PDCCH transmission method according to a first embodiment of the present invention.

Referring to FIG. 7, the base station (BS) performs channel coding of backhaul-associated control information in step S710, and modulates the channel coded result in step S720. If relay backhaul-associated control information is channel-coded and modulated, the R-PDCCH symbol is generated.

The BS distributes and assigns one R-PDCCH symbol to a plurality of OFDM symbols contained in the R-PDCCH region in step S730.

Since the PDCCH region is spread over the entire system bandwidth and the R-PDCCH region is assigned to the PDSCH region of UEs, there is a high possibility that the R-PDCCH region is assigned to a smaller amount of frequency resources as compared to the PDCCH region. Therefore, R-PDCCHs assigned to the R-PDCCH region contained in the limited frequency domain have difficulty to obtain sufficient frequency diversity. In order to reduce such difficulty, the embodiments of the present invention perform R-PDCCH interleaving for each OFDM symbol so that it can increase R-PDCCH coverage. Interleaving for each OFDM symbol can be applied to the localized R-PDCCH region and the distributed R-PDCCH region. Especially, if numbers of OFDM symbols of individual R-PDCCH regions are different from each other in the distributed R-PDCCH region, interleaving for each symbol may be separately applied to each region.

In order to perform interleaving for each symbol, the BS distributes and assigns one R-PDCCH symbol to a plurality of OFDM symbols contained in the R-PDCCH region.

That is, R-CCE constructing one R-PDCCH is divided into the number of OFDM symbols contained in the R-PDCCH region, such that some parts of one R-PDCCH are assigned to each OFDM symbol contained in the R-PDCCH region. In this case, if the R-CCE aggregation level supports 1, 2, 4 and 8, one R-PDCCH may be composed of one R-CEE, 2 RCCEs, 4 R-CCEs, or 8 R-CCEs. The number of OFDM symbols contained in the R-PDCCH may be semi-statically constructed or be dynamically signaled through R-PCFICH.

For example, assuming that the R-CCE unit is composed of 36 REs, R-PDCCH is transmitted using the R-CCE aggregation level of 1, and the R-PDCCH region includes 6 OFDM symbols, if 36 REs used for one R-PDCCH transmission is divided by 6, 6 RE units are obtained. As a result, 6 REs are assigned to one OFDM symbol.

If the R-CCE aggregation level of 2 is used, 72 REs are used for one R-PDCCH transmission. If 72 REs are divided by 6, 12 RE units are obtained such that 12 REs are assigned to one OFDM symbol.

That is, provided that the number of REs contained in the R-PDCCH symbol is exactly divided by the number of OFDM symbols contained in the R-PDCCH region, the number of REs contained in the R-PDCCH symbol is divided by the number of OFDM symbols contained in the R-PDCCH region so as to obtain a quotient, resource units, the number of which is identical to the quotient, are assigned to each OFDM symbol contained in the R-PDCCH region.

Provided that the number of REs constructing the R-PDCCH is not divided by the number of OFDM symbols of the R-PDCCH region, floor, ceil, and round operations are performed so that R-PDCCH can be properly assigned to each OFDM symbol of the R-PDCCH region.

When R-PDCCH is assigned to OFDM symbols of the R-PDCCH region, some parts of the R-PDCCH symbol assigned to each OFDM symbol of the R-PDCCH region may be denoted by an integer multiple of an interleaving unit. In this case, floor, ceil, and round operations are performed so that R-PDCCH can be properly assigned to each OFDM symbol of the R-PDCCH region.

For example, assuming that the R-CCE unit is 48 REs, R-PCCH is transmitted using the R-CCE aggregation level of 1, the R-PDCCH region includes 5 OFDM symbols, and the interleaving unit is 4 REs, 8 REs are assigned to three OFDM symbols, and 12 REs are assigned to two OFDM symbols.

If the number of REs constructing the R-PDCCH is not divided by the number of OFDM symbols of the R-PDCCH region, an OFDM symbol, to which a small-sized part of the R-PDCCH is to be assigned, and an OFDM symbol, to which a large-sized part of the R-PDCCH is to be assigned, can be determined according to the number of reference signals (RSs) of each OFDM symbol, and the presence/absence or amount of R-PCFICH or RN common search space. In other words, according to the above-mentioned example, not only an OFDM symbol to which 8 REs are to be assigned but also an OFDM symbol to which 12 REs are to be assigned can be determined according to the number of RSs of each OFDM symbol, and the presence/absence or amount of R-PCFICH or RN common search space.

The BS multiplexes some parts of R-PFCCHs assigned to each OFDM symbol of the R-PDCCH region in step S740.

If one R-PDCCH is transmitted through one R-PDCCH region, the BS may not perform the step S740.

If R-PDCCHs are transmitted through one R-PDCCH region, the BS assigns each R-PDCCH transmitted to one R-PDCCH region to each OFDM symbol of the R-PDCCH region in steps S710 to S730. In addition, the BS multiplexes some parts of R-PDCCHs assigned to the same OFDM symbol.

For example, some parts of the j^{th} R-PFCCH assigned to the i^{th} OFDM symbol are referred to as ‘i_div_R-PDCCH_j’, the number of R-PDCCHs transmitted to one R-PDCCH region is set to n, and the number of OFDM symbols of the R-PDCCH region is set to 4. The BS simultaneously multiplexes ‘0_div_R-PDCCH_{—}0’, ‘0_div_R-PDCCH_{—}1’, ‘0_div_R-PDCCH_{—}2’, . . . , ‘0_div_R-PDCCH_n−1’, and simultaneously multiplexes ‘1_div_R-PDCCH_{—}0’, ‘1_div_R-PDCCH_{—}1’, ‘1_div_R-PDCCH_{—}2’, . . . , ‘1_div_R-PDCCH_n−1’. The BS simultaneously multiplexes ‘2_div_R-PDCCH_{—}0’, ‘2_div_R-PDCCH_{—}1’, ‘2_div_R-PDCCH_{—}2’, . . . , ‘2_div_R-PDCCH_n−1’, and simultaneously multiplexes ‘3_div_R-PDCCH_{—}0’, ‘3_div_R-PDCCH_{—}1’, ‘3_div_R-PDCCH_{—}2’, . . . , ‘3_div_R-PDCCH_n−1’.

The BS interleaves some parts of the R-PDCCH assigned to each OFDM symbol of the R-PDCCH region, on an OFDM symbol basis in step S750.

If R-PDCCH is transmitted through one R-PDCCH region, some parts of the R-PDCCH assigned to each OFDM symbol are interleaved. That is, some parts of the R-PDCCH assigned to the i^{th} OFDM symbol are interleaved.

If several R-PDCCHs are transmitted through one R-PDCCH region, some parts of the R-PDCCHs assigned to each OFDM symbol are interleaved. That is, some parts of the R-PDCCHs assigned to the i^{th} OFDM symbol are interleaved.

A macro PDCCH is interleaved using the subblock interleaver, and is interleaved at an REG level differently from an original subblock interleaver operating in the bit-level interleaving. The subblock interleaver includes 32 columns, and the number of rows of the subblock interleaver is changed according to the length of resources to be interleaved. The resources to be interleaved are row-wise-input to the subblock interleaver, are interleaved through inter-column permutation, and are column-wise-output. The interleaving is performed to transmit each PDCCH over the entire frequency and time axes of the PDCCH region so as to obtain frequency diversity and coverage from the limited PDCCH region.

In order to transmit individual R-PDCCHs to the entire frequency and time resource regions, the BS interleaves the R-PDCCH using any one of interleaving methods, for example, subblock interleaving, Pseudo random sequence, QPP interleaving, Costas interleaving, etc.

The subblock interleaving is performed through row-by-row input processing, inter-column permutation, and column-by-column output processing. The column size of the subblock interleaver is fixed to 32, and the number of rows is changed according to the amount of resources to be interleaved. If the size of the interleaving unit is too large, or if the number of R-PDCCHs contained in the subframe is too small, one row of the subblock interleaver may not be fully filled with interleaving elements of 32 columns.

If the number of interleaving elements does not reach 32, the interleaving elements are sequentially input to the interleaver, padding or null is input to the remaining empty columns. Alternatively, the interleaving elements are input to 32 columns at intervals of a predetermined distance, and padding or null is inserted into the remaining columns. For example, provided that there are 32 interleaver addresses (0, 1, 2, 3, . . . , 31) and there are 16 interleaving elements, interleaving elements are input to the addresses of 0, 2, 4, 6, . . . , and padding or null is inserted into the remaining addresses of 1, 3, 5, 7, . . . .

If a cell-specific pseudo random sequence is used as a pseudo random sequence, sequence initialization may be set to a cell ID. In case of a distributed R-PDCCH region, if there is a need to differently initialize the sequence in respective R-PDCCH regions, sequence initiation may be performed using the cell ID and the R-PDCCH region specific element. There are various examples of R-PDCCH region specific elements, for example, a PRB index of the R-PDCCH region, an index of the R-PDCCH region, etc. The length of sequence is denoted by ‘ceil (the amount of total resources of R-PDCCH region/interleaving element unit)’.

An interleaving execution unit for each of the above-mentioned interleaving methods is as follows. The interleaving unit of the macro PDCCH of the Rel-8 system is an REG unit of 4 REs.

The interleaving execution unit may be denoted in units of an REG. Interleaving may be performed in units of an REG of 4 REs in the same manner as in the Rel-8 system. Alternatively, if the R-REG unit is configured in the R-PDCCH region differently from the Rel-8 system, interleaving may be performed in units of an R-REG of the R-PDCCH region.

Alternatively, the interleaving execution unit may be denoted by 6 REs, and may be considered to be a distributed virtual resource block (DVRB). Provided that the R-PDCCH interleaving unit is denoted by 6 REs, a pair of two 6REs are mapped to a physical resource, such that the frequency diversity effect is higher than that of the PRB-based mapping and at the same time the R-PDCCH region may have no problems in transmitting R-PDSCH and PDSCH to the remaining regions not used for R-PDCCH transmission. In this case, two 6REs may be a part of the same R-PDCCH or a part of a different R-PDCCH.

Alternatively, the interleaving execution unit includes 12 REs, and such interleaving may be performed in units of one PRB. One PRB may be a constituent element of R-REG or R-CCE. In order to transmit R-PDSCH and PDSCH to the remaining regions not used for R-PDCCH transmission in the R-PDCCH region, it is preferable that interleaving be performed in units of a PRB acting as a PDSCH allocation unit and resource mapping be performed on a PRB basis.

The size of the interleaver and the length of the interleaving sequence may be changed according to the interleaving unit.

In case of transmitting R-PDCCHs using the localized R-PDCCH region, one interleaving may be applied to the R-PDCCH region. In addition, in case of transmitting R-PDCCHs using the distributed R-PDCCH region, interleaving may be separately performed for each R-PDCCH region, or resources of individual R-PDCCH regions are integrated into one such that interleaving can be simultaneously performed in the individual R-PDCCH regions. Provided that resources of individual R-PDCCH regions are integrated into one and interleaving is simultaneously performed in the R-PDCCH regions, one R-PDCCH is not limited only to a specific R-PDCCH region and can be transmitted through all the distributed R-PDCCH regions, such that the frequency diversity can be easily acquired.

The BS may perform cell-specific shifting of the R-PDCCH using the cell ID so as to achieve randomization of inter-cell interference in step S760.

For inter-cell interference randomization in the Rel-8 system, the BS interleaves the macro PDCCH, performs cell-specific shifting of the REG-level sequence using the cell ID, and maps the shifted result to physical resources.

The BS may interleave the R-PDCCH and then shift the interleaved R-PDCCH. Alternatively, the BS may shift the R-PDCCH before interleaving.

If the R-PDCCH region assigned by each cell can be coordinated up to a predetermined level, the operation for inter-cell interference randomization is no longer required. Not all cells may recognize information regarding the R-PDCCH regions of neighbor cells, such that an apparatus for randomizing inter-cell interference may be preferably used.

The BS maps the interleaved R-PDCCH symbol to resources in step S770.

The macro PDCCH of the LTE Rel-8 system is transmitted from the PCFICH through the remaining REs other than REs used for RS, PCFICH, and PFICH transmission within the known PDCCH region.

The BS maps R-PDCCH symbols to the remaining REs other than REs used for transmission of control channels in the R-PDCCH region. For example, cell-specific or RN-specific RS for R-PCFICH and R-PFCCH decoding, R-PHICH for ACK/NACK transmission of uplink traffic, etc. may be used as such control channels.

In this case, if control channels other than the R-PDCCH coexist, R-REG or R-CCE definition may include all control channels other than R-PDCCH, or may exclude REs to which control channels other than R-PDCCH are assigned as necessary. If REs to which control channels other than R-PDCCH are not contained in R-REG or R-CCE, it is preferable that the rate matching structure be used for actual symbol matching. If R-REG or R-CCE definition includes REs to which control channels other than R-PDCCH are assigned, it is preferable that symbol puncturing be performed.

A method for transmitting and receiving R-PDCCH according to a second embodiment of the present invention will hereinafter be described in detail.

The second embodiment of the present invention does not interleave R-PDCCH, and directly maps R-PDCCH to physical resources of the R-PDCCH region using a specific method such as the PHICH mapping of the Rel-8 system.

The second embodiment of the present invention maps the R-PDCCH to physical resources in units of N (or N−1) PRBs. R-PDCCH configuration unit may be M PRBs in consideration of an R-REG or R-CCE unit (where M N)

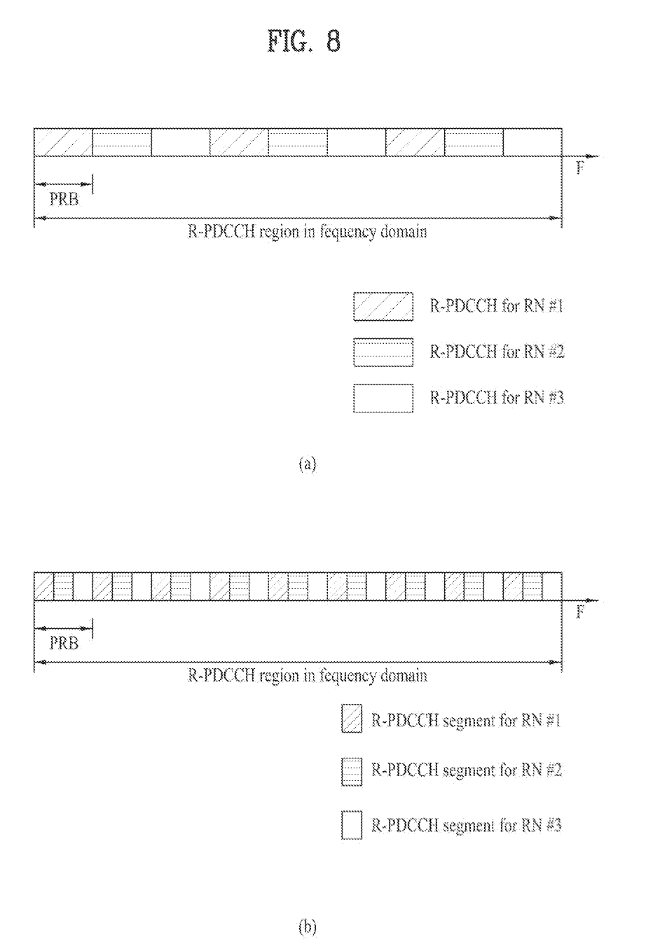

If R-PDCCH is mapped to physical resources in units of N PRBs, N PRBs may be all or some parts of the R-PDCCh regarding one relay node (RN). FIG. 8(a) shows an exemplary case in which N PRBs occupy all or some parts of R-PDCCH of one relay node (RN).

Although FIG. 8(a) shows that R-PDCCH is transmitted through one OFDM symbol under the condition of N=1 and M=3, the second embodiment can also be applied to another case in which N is different from M and R-PDCCH is transmitted through several OFDM symbols.

Alternatively, R-PDCCH of each relay node (RN) is divided into units (for example, units smaller than R-REG, R-CCE or other N PRBs, i.e., R-PDCCH segment may be R-REG or R-CCE) smaller than N PRBs and then transmitted. A collection unit of R-PDCCH segments of one or more RNs may construct N PRBs.

FIG. 8(b) shows an exemplary case in which R-PDCCH of each RN is transmitted in units of a smaller unit than N PRBs.

Although FIG. 8(b) shows that R-PDCCH is transmitted through one OFDM symbol under the condition of N=1, M=3, and R-PDCCH segment composed of 4 REs, the second embodiment can also be applied to another case in which N is different from M, the R-PDCCH segment is composed of a different number of REs, and R-PDCCH is transmitted through several OFDM symbols.

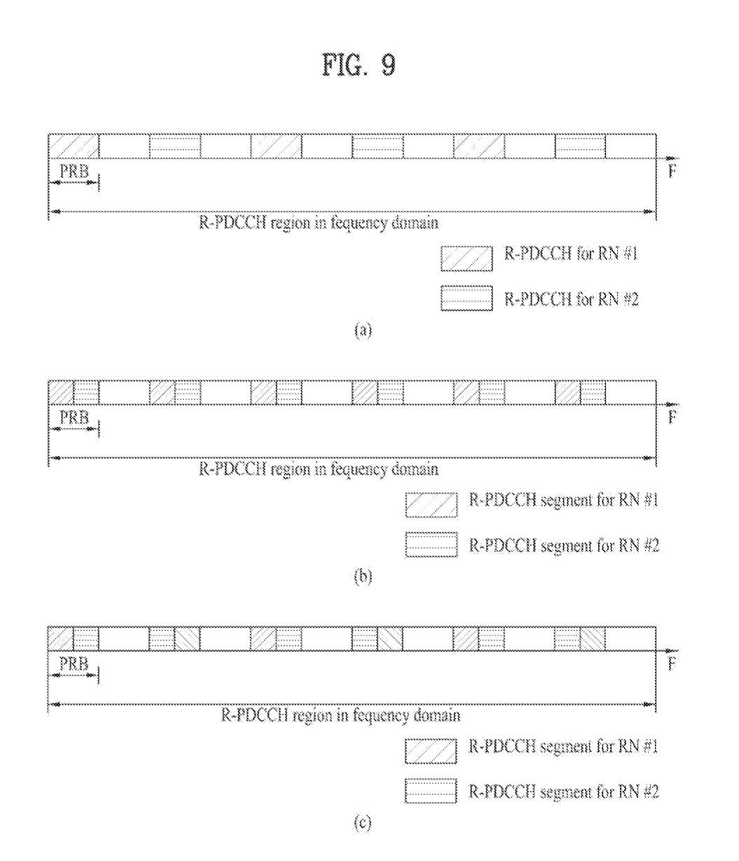

FIG. 9 is a conceptual diagram illustrating a physical resource mapping method of another frequency domain according to a second embodiment of the present invention.

Referring to FIG. 9(a), if one R-PDCCH is uniformly mapped to the frequency domain resource of the R-PDCCH region at regular intervals, R-PDCCHs may obtain the frequency diversity effect in the limited R-PDCCH region. In this case, the R-PDCCH unit mapped to the physical resource is denoted in units of N PRBs. Although FIG. 9(a) shows the exemplary case of M=3 and N=1, it should be noted that the present embodiment can also be applied to the other case in which N is different from M.

FIGS. 9(b) and 9(c) show that each R-PDCCH unit of relay nodes is divided into R-PDCCH segments, R-PDCCH segments of several RNs are multiplexed, and the multiplexed result is mapped to physical resources in units of N PRBs. FIGS. 9(b) and 9(c) show that the R-PDCCH segment is composed of 6 REs under the condition of M=3 and N=1. As shown in FIG. 9(b), PRB segments may always be transmitted to the same position within N PRBs. As shown in FIG. 9(c), PRB segments may also be transmitted to different positions within N PRBs.

Although FIG. 9 shows an example in which R-PDCCH is mapped in one OFDM symbol at regular frequency intervals, the present embodiment can also be applied to another example in which the R-PDCCH region is defined using several OFDM symbols.

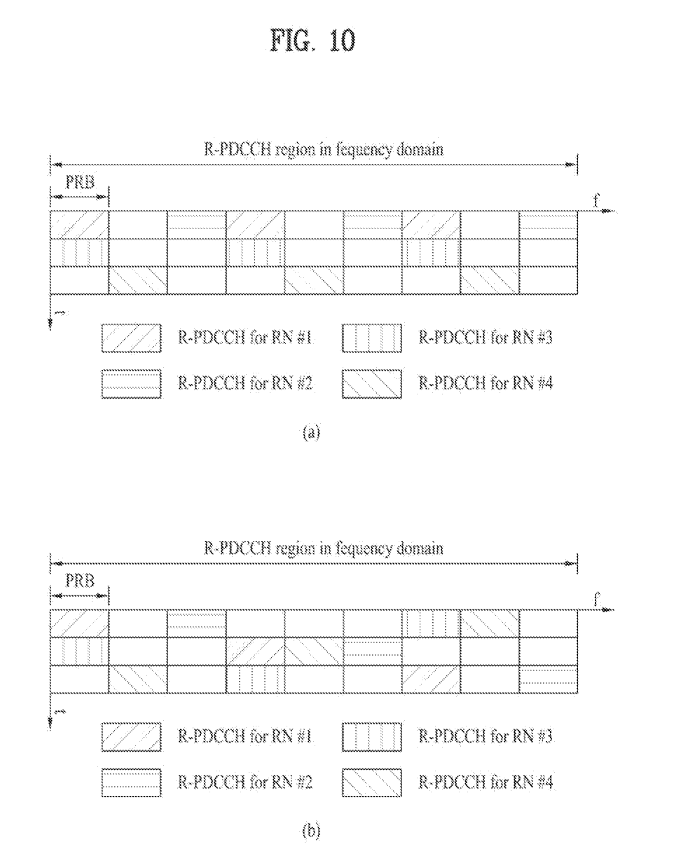

FIG. 10 is a conceptual diagram illustrating a physical resource mapping method of another time domain according to a second embodiment of the present invention.

In addition to the physical resource mapping method of the frequency domain, the second embodiment of the present invention provides a physical resource mapping method of a time domain under the condition that multiple R-PDCCH transmission symbols are used. It is assumed that the time domain resources of the R-PDCCH region is semi-statically defined or is dynamically changed through the same channel as R-PCFICH, and it is also assumed that the relay node and the BS share information of the time domain resources of the R-PDCCH region.

FIG. 10(a) shows an exemplary case in which each R-PDCCH for each relay node is transmitted through one OFDM symbol. FIG. 10(b) shows another case in which each R-PDCCH for each relay node is transmitted through multiple OFDM symbols. FIG. 10 shows an exemplary case in which the number of OFDM symbols of the R-PDCCH region is set to 3 under the condition of N=1 and M=3.

Although FIG. 10 shows the exemplary case in which R-PDCCH is mapped in units of a PRB, the mapping method based on R-PDCCH segments proposed in the aforementioned frequency domain resource mapping method can also be applied to a transmission method based on multiple OFDM symbols.

When mapping R_PDCCh to physical resources, the position of resources mapped to the R_PDCCH using the cell ID may be randomized within each cell.

The R-PDCCH mapping method according to the second embodiment of the present invention can be applied to the localized R-PDCCH region and the distributed R-PDCCH region.

The R-PDCCH search space will hereinafter be described in detail.

In order to decode PDCCHs transmitted in the macro PDCCH region, the search space is defined in a logical domain. The search space is classified into a common search space and a UE-specific space according to PDCCH categories. Common control information is mainly transmitted in the common search space, and UE-specific downlink and uplink grant information is mainly transmitted in the UE-specific search space.

Even in the case of R-PDCCH transmission, the search space can be classified into the common search space and the RN-specific search space according to R-PDCCH categories. Common control information may be mainly transmitted in the common search space, and RN-specific downlink and uplink grant information may be mainly transmitted in the RN-specific search space. There is a variety of common control information, for example, RACH response, PDCCH for system information, power control information, etc.

If the R-PDCCH region is changeable, a method for fixing the position of a common search space may be needed. Such fixing may be needed in the RN-specific search space, such that the scheme for operating a specific RN is not affected by other RNs.

In order to guarantee the common search space irrespective of variance of the R-PDCCH region, the first Nc OFDM symbols of the R-PDCCH region are used as the common search space, and the RN-specific search space can be transmitted through the remaining OFDM symbols. In this case, if a large amount of available resources are located on the frequency axis, the RN-specific search space may also coexist with the OFDM symbol including the common search space. However, although the RN-specific search space is defined, the positions of physical R-CCEs of the common search space may be preferably unchanged. Preferably, the RN-specific search space is increased in size in proportion to the number of OFDM symbols used for R-PDCCH. Actually, the physical position occupied by each logical search space may be constantly determined irrespective of the number of used OFDM symbols.

In case of the distributed R-PDCCH region, a common search space and a RN-specific search space may be transmitted in different R-PDCCH regions. In FIG. 6, one R-PDCCH region is used for transmission of the common search space. Preferably, the RN-specific search space may be transmitted through one or more R-PRCCH regions, and the common search space may be transmitted through one PRCCH region.

Preferably, the R-PDCCH region for transmission of the common search space may be semi-statically fixed through higher layer signaling. In addition, the RN-specific search space may be transmitted to a fixed position through higher layer signaling. That is, provided that the search space construction is defined irrespective of the amount of resources used by R-PDCCH, physical resources may be configured to have the same positions when using a specific logical search space, such that it may also be possible to construct the higher layer signaling without using dynamic information.

In case of a PDCCH of the LTE Rel-8 system, a CCE index from which PDCCH decoding of UE-specific search spaces starts is determined on the basis of a hashing function. The hashing function based on the relay node ID may also be applied to the RN-specific search space of R-PDCCHs. Alternatively, the RN-specific search space may be configured through higher layer signaling such as RN-specific RRC signaling.

If the RN-specific search space is configured through RN-specific higher layer signaling, an R-CCE index, an R-CCE aggregation level, etc. of the search space in which the corresponding RN is going to decode the R-PDCCH can be signaled. In this case, the transmitted R-CCE index or R-CCE aggregation level may be set to a specific value, and one or more specific values capable of being used as a candidate group may be signaled. As a result, blind decoding complexity encountered when the relay node (RN) searches for its own R-PDCCH in the R-PDCCH region can be largely reduced.

One DCI format for one UE in the LTE Rel-8 system generates one encoding block through one decoding process. Generation of the single encoding block means that one CRC is attached to one control channel. Even in the case of R-PDCCH for the relay node (RN), a control channel of the single relay node (RN) may generate one encoding block through one decoding process. Alternatively, if R-PDCCH is transmitted and mapped through one or more PRBs, CRC may be located in units of N PRBs during the decoding such that the R-PDCCH can be self-decoded in units of N PRBs. In this case, R-PDCCH control information transmitted in units of N PRBs may be control information of the same relay node, or may also be control information of different relay nodes.

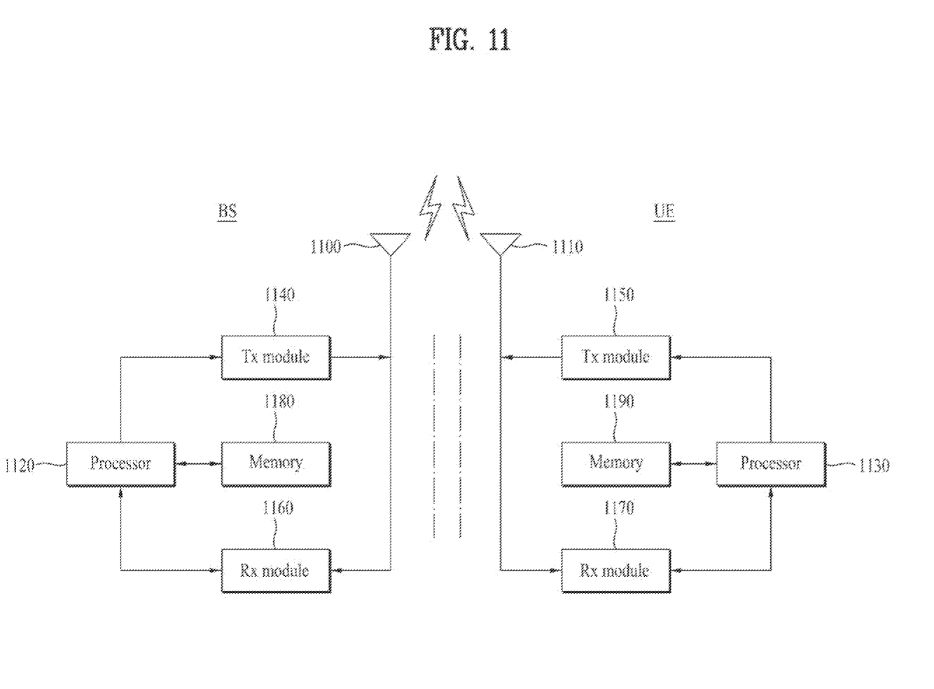

FIG. 11 is a block diagram illustrating a base station (BS) and a relay node (RN) applicable to embodiments of the present invention.

Referring to FIG. 11, each of the RN and the BS (also called ‘ABS’) may include an antenna 1100 or 1110 for transmitting and receiving information, data, signals and/or messages, a Transmission (Tx) module 1140 or 1150 for transmitting messages by controlling the antenna 1100 or 1110, a Reception (Rx) module 1160 or 1170 for receiving messages by controlling the antenna 1100 or 1110, a memory 1180 or 1190 for storing information related to BS communication, and a processor 1120 or 1130 for controlling the memory 1180 or 1190. In this case, the BS may be a femto BS (FBS) or a macro BS (MBS). The components of the RN are the counter parts of those of the BS.

The antennas 1100 and 1110 include Tx antennas for transmitting signals generated from Tx modules 1140 and 1150 and Rx antennas for receiving radio frequency (RF) signals and providing the received RF signals to the Rx modules 1160 and 1170. If Multiple Input Multiple Output (MIMO) is supported, two or more antennas may be provided.

The processors 1120 and 1130 generally provide overall control to the RN and the BS, respectively. Especially, the processors 1120 and 1130 may perform a control function for implementing the above-described exemplary embodiments of the present invention, a variable MAC frame control function based on service characteristics and a propagation environment, a handover function, an authentication and encryption function, etc. In addition, each of the processors 1120 and 1130 may include an encryption module for controlling encryption of various messages and a timer module for controlling transmission and reception of various messages.

The processor 1120 of the BS distributes and assigns a first PDCCH symbol into several OFDM symbols contained in the R-PDCCH region, and some parts of the first R-PDCCH symbol assigned to each OFDM symbol are interleaved per OFDM symbol so that a first R-PDCCH is generated.

The processor 1120 of the BS distributes and assigns a second PDCCH symbol into several OFDM symbols contained in the R-PDCCH region, and some parts of the first R-PDCCH symbol assigned to the same OFDM symbol and some parts of the second PDCCH symbol are multiplexed in each of the OFDM symbols. In addition, some parts of the first R-PDCCH symbol assigned to each OFDM symbol and some parts of the second R-PDCCH symbol are interleaved per OFDM symbol.

The processor 1130 of the relay node (RN) may decode R-PDCCH received from the BS.

The Tx modules 1140 and 1150 may encode and modulate transmission data scheduled by the processors 1120 and 1130 according to a predetermined coding and modulation scheme and provide the modulated data to the antennas 1100 and 1110.

The Tx module 1140 of the BS transmits R-PDCCH to a UE.

The Rx modules 1160 and 1170 may recover original data by demodulating and decoding data received through the antennas 1100 and 1110 and provide the recovered data to the processors 1120 and 1130.

The Rx module 1170 of the UE receives R-PDCCH from the BS.

The memories 1180 and 1190 may store programs for processing and control of the processors 1120 and 1130 and temporarily store input/output data (on the side of the UE, an uplink grant received from the BS, system information, a station identifier (STID), a flow identifier (FID), an action time, area assignment information, frame offset information and the like).

Each of the memories 1180 and 1190 may include at least one type of storage media such as a flash memory, a hard disk, a multimedia card micro memory, a card-type memory (e.g. a Secure Digital (SD) or eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable Read-Only Memory, a magnetic memory, a magnetic disc, an optical disc, etc.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other.

Accordingly, the invention should not be limited to the specific embodiments described herein, but should be accorded the broadest scope consistent with the principles and novel features disclosed herein.

1. A method for transmitting a control channel for a backhaul link by a base station (BS) of a wireless communication system, the method comprising:
distributing and assigning a first relay physical downlink control channel (R-PDCCH) symbol to a plurality of OFDM symbols of an R-PDCCH region; and
interleaving some parts of the first R-PDCCH symbol assigned to each OFDM symbol, on an OFDM symbol basis.

2. The method according to claim 1, further comprising:
distributing and assigning a second PDCCH symbol to the OFDM symbols; and
multiplexing, in association with each OFDM symbol, some parts of the first R-PDCCH symbol assigned to the same OFDM symbol and some parts of the second PDCCH symbol.

3. The method according to claim 2, wherein the interleaving step includes:
interleaving some parts of the first R-PDCCH symbol assigned to each of the OFDM symbol and some parts of the second R-PDCCH symbol, on an OFDM symbol basis.

4. The method according to claim 1, wherein:
if the number of resource elements (REs) contained in the R-PDCCH symbol is exactly divisible by the number of OFDM symbols, the assigning step assigns resource units, the number of which is identical to a quotient obtained when the number of REs contained in the R-PDCCH symbol is divisible by the number of OFDM symbols, to each of the OFDM symbols.

5. The method according to claim 1, wherein the assigning step enables some parts of the R-PDCCH symbol assigned to each OFDM symbol to be denoted by an integer multiple of an interleaving unit.

6. A method for receiving a control channel for a backhaul link by a relay node (RN) of a wireless communication system, the method comprising:
receiving a relay physical downlink control channel (R-PDCCH) generated when a first R-PDCCH symbol is distributed and assigned to a plurality of OFDM symbols of an R-PDCCH region and some parts of the first R-PDCCH symbol assigned to each OFDM symbol are interleaved on an OFDM symbol basis; and
decoding the R-PDCCH.

7. The method according to claim 6, wherein:
if the number of resource elements (REs) contained in the R-PDCCH symbol is exactly divisible by the number of OFDM symbols, the R-PDCCH symbol's resource units, the number of which is identical to a quotient obtained when the number of REs contained in the R-PDCCH symbol is divisible by the number of OFDM symbols, are assigned to each OFDM symbol.

8. The method according to claim 6, wherein some parts of the R-PDCCH symbol assigned to each OFDM symbol are denoted by an integer multiple of an interleaving unit.

9. A base station comprising:
a processor for generating a first relay physical downlink control channel (R-PDCCH), by distributing/assigning a first R-PDCCH symbol to a plurality of OFDM symbols of an R-PDCCH region and interleaving some parts of the first R-PDCCH symbol assigned to each OFDM symbol on an OFDM symbol basis; and
a transmission module for transmitting the first R-PDCCH.

10. The base station according to claim 9, wherein the processor distributes/assigns a second PDCCH symbol to the OFDM symbols, and multiplexes, in association with each OFDM symbol, some parts of the first R-PDCCH symbol assigned to the same OFDM symbol and some parts of the second PDCCH symbol.

11. The base station according to claim 10, wherein the processor interleaves some parts of the first R-PDCCH symbol assigned to each OFDM symbol and some parts of the second R-PDCCH symbol, on an OFDM symbol basis.

12. The base station according to claim 9, wherein:
if the number of resource elements (REs) contained in the R-PDCCH symbol is exactly divisible by the number of OFDM symbols, the processor assigns resource units, the number of which is identical to a quotient obtained when the number of REs contained in the R-PDCCH symbol is divisible by the number of OFDM symbols, to each of the OFDM symbols.

13. The base station according to claim 9, wherein the processor enables some parts of the R-PDCCH symbol assigned to each OFDM symbol to be denoted by an integer multiple of an interleaving unit.

14. A relay node (RN) comprising:
a reception module for receiving a relay physical downlink control channel (R-PDCCH) generated when a first R-PDCCH symbol is distributed and assigned to a plurality of OFDM symbols of an R-PDCCH region and some parts of the first R-PDCCH symbol assigned to each OFDM symbol are interleaved on an OFDM symbol basis; and
a processor for decoding the R-PDCCH.

15. The relay node (RN) according to claim 14, wherein:
if the number of resource elements (REs) contained in the R-PDCCH symbol is exactly divisible by the number of OFDM symbols, the R-PDCCH symbol's resource units, the number of which is identical to a quotient obtained when the number of REs contained in the R-PDCCH symbol is divisible by the number of OFDM symbols, are assigned to each OFDM symbol.

16. The relay node (RN) according to claim 14, wherein some parts of the R-PDCCH symbol assigned to each OFDM symbol are denoted by an integer multiple of an interleaving unit.
